(19) United States
(12) Patent Application Publication
(10) Pub. No.: US 2007/0079518 A1
(43) Pub. Date: Apr. 12, 2007

(54) Tile positioning device

(76) Inventors: Paul Martin, Dundalk (IE); Derek Clelland, Dundalk (IE)

Correspondence Address: TAROLLI, SUNDHELM, COVELL & TUMMINO, LLP, 1300 EAST NINTH STREET, SUITE 1700, CLEVELAND, OH, 44114, US

(21) Appl. No.: 10/578,741

(22) PCT Filed: Nov. 12, 2004
(86) PCT No.: PCT/IE04/00159

§ 371 Date: Jun. 8, 2006

(30) Foreign Application Priority Data
Nov. 14, 2003 (IE) S2003/0855

(51) Int. Cl. G01D 21/00

(52) U.S. Cl. 33/645

(57) ABSTRACT

A tile positioning device for height adjusting a tile located on a roof hip or ridge joint, each tile having upper and lower faces. The device comprises two opposing longitudinal spaced apart side members arranged for straddling a roof hip or ridge joint, means for maintaining the longitudinal side members in a substantially parallel configuration, and at least one tile-pressing element mounted between the longitudinal side members. The or each tile-pressing element being arranged to act upon the upper face of a tile located between the longitudinal side members, so as to height position the tile relative to the device.

### FIELD OF THE INVENTION

The invention relates to a device for and method of height adjusting a tile located on a roof hip or ridge joint.

### BACKGROUND TO THE INVENTION

Hips and ridges are formed where two inclined faces of a roof meet. The hip or ridge requires a uniquely shaped tile, which is typically of v-shaped cross-section. Hip and ridge tiles are typically the last tiles (roofing elements) to be laid on a roof, following the laying of standard roof tiles (roofing elements) along the inclined faces of the roof.

When working on a roof, a roofer may rely on a roof ladder as a means of support. Standard roof ladders are of little use when working on a hip as the ladder rungs prevent the ladder from straddling the hip or the ridge. This lead to the development of hip or ridge ladders which are well known in the art and need not be described further herein. One embodiment is shown for example in UK Patent Application No. GB2305208.

Roofers have typically relied upon visual inspection to ensure hip tiles are laid in alignment along the hip of a roof. Typically a roofer working on the roof would align consecutive tiles with the assistance of a colleague on the ground, the ground based worker having the advantage of a better perspective.

The inefficiency in terms of manpower and time has led to the development of tile alignment aids. Typically, such aids comprise a pair of side guide members held parallel to one another by a plurality of bridging members. In use, the side guide members straddle the hip of the roof thereby defining a tile placement area between the guide members. Tiles are laid between the guide members and the device subsequently removed. The resultant line of tiles is in alignment with one another along the line of the hip.

UK patent application number GB2281092 describes a ridge tile guide comprising a pair of mutually parallel guide rails linked by one or more bridging connectors shaped to arch over a line of ridge tiles or hip tiles, which are positioned between the guide rails, in use, the bridging connector being adjustable to adjust the width separation between the opposing guide rails to suit the required tile width.

UK patent application number GB2336389 describes a device for fixing hip or ridge tiles on a roof, wherein two battens are rigidly secured to one another by means of U-shaped brackets to lie parallel and spaced by a distance equal to the width of the angled hip or ridge tiles. The battens are placed so as to straddle the hip or ridge, and the tiles are cemented thereto, whilst the battens act both as alignment guides and temporary shutters for the cement. The spacing between the battens is adjustable by sliding the L-section members relative to each other, and securing them with a clamping nut.

Safety is of utmost importance when carrying out work at height on roofs. A drawback of the tile alignment arrangements described hereinbefore is that they tend to be unstable and therefore pose a risk of injury to the roofer. It is therefore an object of the invention to provide a tile alignment or positioning device having improved safety features for the user.

A further problem with the known devices is that while they provide means for aligning the tiles relative to the line of the hip, they offer no solution to the problem of ensuring that each consecutive tile is level with the next. When laying hip tiles, an adhesive, typically a mortar mix, is first applied to the underlying roof surface along the hip. Typically, each tile is subsequently laid onto the mortar along the hip in end-to-end abutment.

Whether relying on unaided methods or using an alignment device of the type described herein before, the roofer typically beds the tile into the mortar by applying pressure to the tile by hand. The roofer typically will rely on visual inspection to ensure the resultant line of tiles is level relative to the hip and to each other. This may also require assistance from a colleague on the ground.

It is therefore a further aim of the invention to provide a tile-positioning device that enables a level line of tiles to be laid without third party assistance.

### SUMMARY OF THE INVENTION

Accordingly, there is provided, according to a first aspect of the invention, a tile positioning device for height adjusting a tile located on a roof hip or ridge joint, each tile having upper and lower faces, the device comprising:
two opposing longitudinal spaced apart side members arranged for straddling a roof hip or ridge joint,
means for maintaining the longitudinal side members in a substantially parallel configuration, and
at least one tile-pressing element mounted between the longitudinal side members,
the or each tile-pressing element being arranged to act upon the upper face of a tile located between the longitudinal side members, so as to height position the tile relative to the device.

Preferably, the two opposing longitudinal side members are sufficiently spaced apart to accommodate a tile there between. In use this typically means that the device can straddle a hip or ridge joint.

An advantage of the device is that the longitudinal side members act as guides to ensure each tile of a line of tiles are laid in a straight line. The tile-pressing element ensures that each tile of the line of tiles is positioned at the same height relative to the device, the roof joint and each other. As far as the present inventors are aware no other device or method can achieve all of these desirable aspects simply and efficiently.

Preferably, the at least one tile-pressing element has a degree of freedom along an axis perpendicular to the longitudinal axis of the longitudinal side members. The tile-pressing element may be adjustable to allow for adjustment in pressing of tiles, for example those of different dimensions (e.g. taller or shorter) and/or to different height requirements (e.g. seated lower on (closer to) or seated higher on (further away from) a ridge or hip joint)

Preferably, the at least one tile-pressing element has a degree of freedom along the longitudinal axis of the side members. This allows for adjustment of the tile-pressing element along the device as required, for example to act on a given tile at a desired position.

These are two main movements of the tile-pressing element. Preferably, the at least one tile-pressing element can be positioned for use using a combination of these movements. Any combination of movements may be used to effect a resultant displacement of the tile towards the roof joint.

Additionally or alternatively, the tile-pressing element is mounted to a carrier or actuating portion which has a first end which is pivotably mounted on the device, and a second free end, so as to allow the tile-pressing element to be moved from an operative position (which in general will be a tile contacting position) to an inoperative position where the free end of the carrier is pivoted away from the device (for example no longer projecting above the space between the side members). This provides a very simple arrangement where the tile-pressing element can be pivoted away from the operative position, for example to allow mortar and/or a ridge tile to be placed between the side members without obstruction from the tile-pressing element, and then the tile-pressing element can be easily pivoted back (for example over the mortar/tile) into the operative position to press the ridge or hip tile to a desired extent. In this way the device can effect a desired displacement of the tile to an aligned position. To this end, it is desirable that the axis of pivoting is substantially parallel to a longitudinal axis of the side members.

Preferably, the at least one tile-pressing element is slidable longitudinally along the length of the device. This allows for pressing on the tile at any desired position(s) along its length. Generally it has been found that with the device of the present invention one pressing action may be adequate to achieve the desired positioning.

Desirably, the at least one tile-pressing element comprises an actuating portion and a tile engaging portion.

The tile-engaging portion may be an integral part of the tile-pressing element, such as a face or an edge thereof. For example in one embodiment of the tile-pressing element, the tile-engaging portion may be the base of the tile-pressing element. Alternatively the tile-engaging portion may be an independent part of the tile-pressing element. For example the tile-engaging portion may comprise a tile-pressing element which is mounted on a carrier and which is adjustable relative to the carrier. For example the tile-pressing element may be height adjustable on the carrier.

According to a second embodiment of tile-pressing element, the tile-engaging portion comprises a pair of pads for engagement with the upper face of a tile having an apex, (the tile generally will have opposing converging sides which meet at an apex) wherein each pad is positioned to engage the upper face of the tile at either side of the apex. Preferably, the pads are pivotable relative to upper face of the tile. This improves the coupling (contact) between the pad and the tile.

Preferably, the actuating portion of the tile-pressing element comprises a handle. The handle may be spring-loaded. In this embodiment the handle forms a carrier for the tile-pressing element, as described above.

Desirably, the means for maintaining the longitudinal side members in a substantially parallel configuration is adjustable so as to allow the spacing between the longitudinal side members to be varied.

In one construction, at least one connector links the longitudinal side members. Each connector is desirably of variable length so as to enable the spacing between the longitudinal side members to be varied in accordance with the width of tile to be laid.

The two respective opposing ends of the longitudinal side members may be linked by a pair of connectors. In a first embodiment of the invention, each connector is telescopic.

In a second embodiment of the invention, each connector is a rod, having one end fixed to one side member and a second end receivable into the second side member.

Preferably, locking means are provided to lock the device at a desired width.

Preferably securing means are provided for securing the position of the device relative to a tile. Preferably the securing means compromises a safety line attachable to a roof ridge.

Preferably, the device further comprises at least one handle for carrying the device.

Preferably, the device further comprises support means for supporting a user of the device. Preferably, the support means are hand and/or foot holds.

According to one embodiment of the invention, the hand and/or footholds are displaceable between an in-use position and a stowed position. Preferably, in an in-use position the foot holds extent outwardly from the side members. Desirably, in a stowed position, the footholds are upright relative to the device. The footholds may be biased towards their stowed position using a system of springs.

Desirably, the device further comprises one or more tile protection members. Each tile protection member may be absorbent. Each tile protection member may suitably be formed on a tile-abutting surface of the longitudinal side members. Alternatively, each protection member may be a separate member adapted to fit between a tile and a longitudinal side member. Desirably, each tile protection member runs at least 75% of the length of a tile. Preferably, each tile protection member runs along the whole length of the tile. A suitable material for the tile protection member may be wood.

A further aspect of the present invention relates to a kit comprising a tile-positioning device according to the present invention and a securing element having a base with at least one fixing member extending therefrom for affixing to a roof member; a retaining member on the base, the retaining member forming an anchor point to which a securing line can be attached. Desirably the retaining member has a retaining eye to which a securing line can be fastened. The kit may additionally comprise a securing line for securing the tile positioning device to the securing element. The securing member itself may be considered a further aspect of the present invention.

In one arrangement the securing element is constructed of interconnecting components and comprising:
a first component which is a securing element having a base with at least one fixing member extending therefrom for affixing to a roof member
a second component which is connectable to the first component to form the retaining member. Having interconnecting parts means that one part (the first component) may be left in its secured position after it has been used and the second component removed for re-use. It is thus possible for example to tile over the first component (for example by burying it in mortar or the like) or to leave it exposed for future use (for example for roof maintenance). In this way the safety of operating the tile positioning device of the invention is improved.

The first and second components may be reciprocally screw-threaded so that they can be interengaged by screw-threading. In one arrangement the first component has an upstanding member which is adapted to project above the roof, when in use. In particular it is desirable that the upstanding member and the second component together project proud of the height level of any tiles to be laid by the device. In particular it is desirable that the second component can be removed after any tiles are laid. In this respect the second component may comprise an eye to which a securing line can be fastened.

For increased safety it is desirable that the securing element has at least two fixing members extending therefrom in different directions, each for affixing to a roof member. In particular it is desirable that the securing element has at least three fixing member extending therefrom in different directions, each for affixing to a roof member. This is particularly useful for example where a roof frame is erected with a transverse ridge roof beam and two hip roof beams which converge toward the ridge roof beam, a securing device having the three securing elements can be arranged each to be affixed to one of the ridge beam or hip beams. In this way the securing device can be used to secure the device of the invention when in use to lay tiles along the ridge, or along either of the hips of the roof. This provides a simple yet highly efficient way of securing the tile-positioning device of the invention. It also provides for maximum efficiency as on most roofs one or two securing devices will be sufficient to tile the roof in safety.

The fixing members may be adjustable relative to each other so as to be securable to roof members at different relative orientations to each other. The fixing members are desirably sufficiently flexible to allow them to adjust to the profile of the roof members to which they are to be affixed. For example they may be in the form of metal straps which can be bent into a desired shape.

In accordance with a further aspect of the invention, there is provided a method of height adjusting a tile located on a roof hip or ridge joint, each tile having upper and lower faces, comprising the steps of:

applying an amount of workable bonding material to the hip or ridge joint, and

using the device of any preceding claim to bed each tile into the bonding material so as to height position each tile relative to the device.

Preferably, the method further comprises the step of positioning the device so as to straddle the hip or ridge joint prior to (i) applying the bonding material to the joint, and/or (ii) placing the tile on the roof.

In addition to the steps described above the method may comprise the step of affixing a securing element of the type described above to at least one roof member, and providing a securing line between the securing element and the tile positioning device to secure the tile positioning device to the securing element. This then provides a safe way of operating the tile positioning device.

In accordance with a yet further aspect of the invention, there is provided a tile positioning device for positioning a tile on a roof hip or ridge joint, the device comprising:

two opposing longitudinal spaced apart side members arranged for straddling a roof hip or ridge joint,

means for maintaining the longitudinal side members in a substantially parallel configuration, and

at least two foot holds extending outwardly from the device.

It will be appreciated that the footholds enable the user to stand on or over the device. The undesirable necessity of standing directly on the roof has therefore been removed. It will be appreciated that the footholds may be further used as handholds to support the upper body of the user.

As previously described with reference to the first embodiment of device, the footholds are preferably displaceable between an in-use position and a stowed position.

Various embodiments of the invention will now be described having regard to the following drawings.

### BRIEF DESCRIPTION OF THE DRAWINGS

FIG. 1 is perspective view is of a tile positioning device according to a first aspect of the invention;

FIG. 2 is an enlarged view of a portion of the device of FIG. 1;

FIG. 3 is a plan view of the device of FIG. 1;

FIG. 4 is side view of the device of FIG. 1;

FIG. 5 is an end view of the device of FIG. 1;

FIG. 6 is a perspective view of the tile-pressing element and carrier of the device of FIG. 1;

FIG. 7 is a side view of the tile-pressing element and carrier of FIG. 6;

FIG. 8 is a plan view of the tile-pressing element and carrier of FIG. 6;

FIG. 9 is a diagrammatic representation of the device of FIG. 1 in use on the hip of a roof;

FIG. 10 is a cross-sectional view of the device and hip of FIG. 9;

FIG. 11 is a perspective view of a device according to a second aspect of the invention;

FIG. 12 is plan view of a device of FIG. 11;

FIG. 13 is side view of the device of FIG. 11;

FIG. 14 is an end view of the device of FIG. 11;

FIG. 15 is an expanded perspective view of the device of FIG. 11;

FIG. 16 is a cross-sectional view of the device of FIG. 11 in position on a hip in a non-tile-engaging disposition;

FIG. 17 is a cross-sectional view of the device of FIG. 11 in position on a hip in a tile-engaging disposition;

FIG. 18 is a perspective view (from above) of tile positioning device, which is very similar in construction to that shown in the previous Figures;

FIG. 19 is a perspective view (from below) of the tile positioning device of FIG. 18;

FIG. 20 is an enlarged perspective view (from above) of the circled portion “C” of the tile positioning device of FIG. 18;

FIG. 21 is an enlarged perspective view (from below) of the circled portion “A” of the tile positioning device of FIG. 19;

FIG. 22 is an enlarged perspective view of a foothold (or rung) on the tile positioning device of FIG. 18;

FIG. 23 is an enlarged perspective view of a tile-pressing element on a carrier/handle which is present in the tile positioning device of FIG. 18;

FIG. 24 is a perspective view of a securing element suitable for use with a tile positioning device of the present invention;

FIG. 25 is a perspective view of the device of FIG. 24 affixed to roof members with a tie line attached thereto.

### DETAILED DESCRIPTION OF THE DRAWINGS

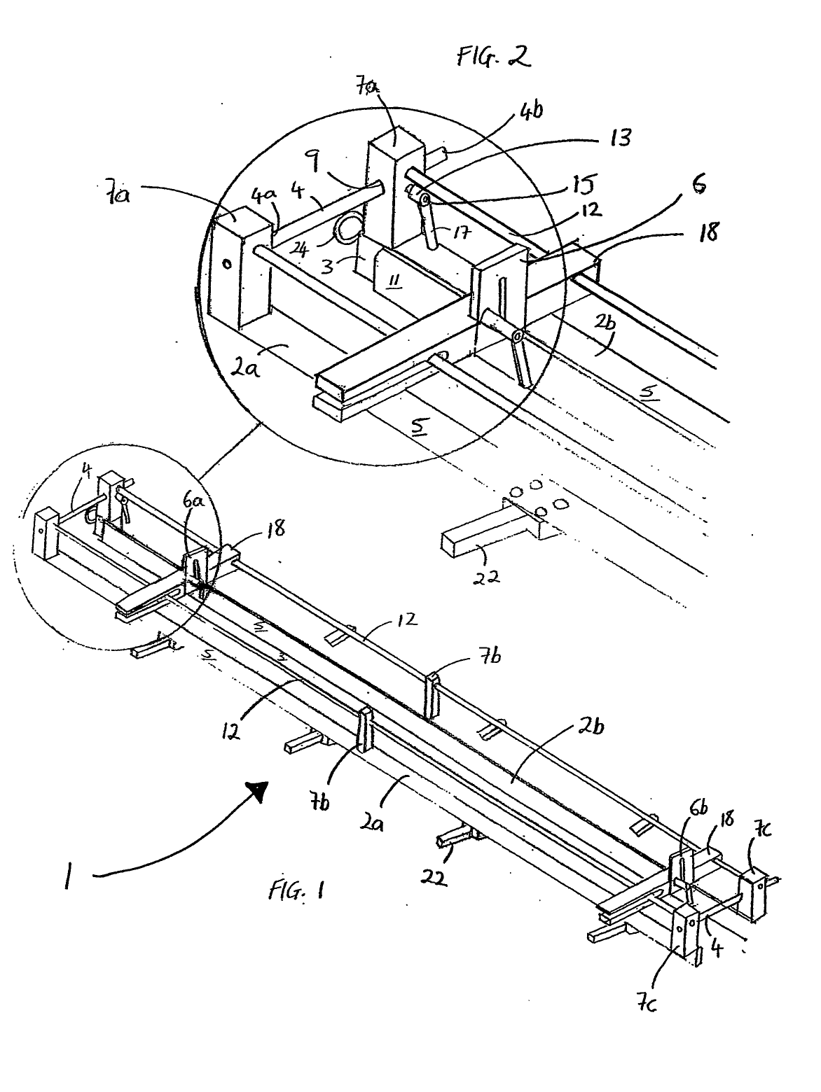

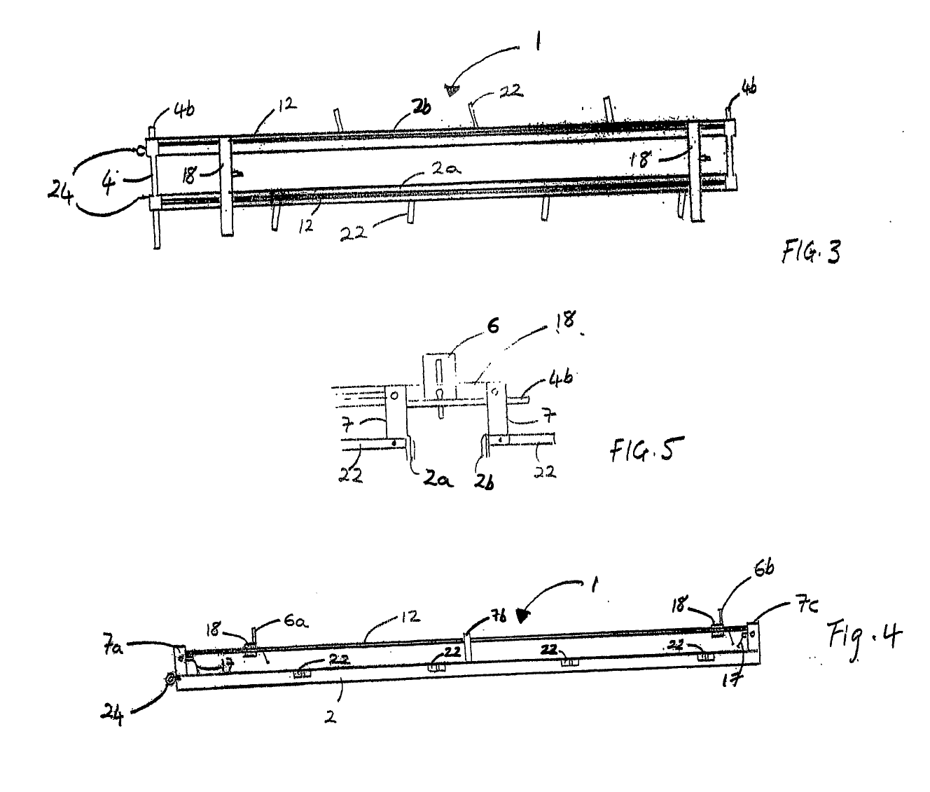

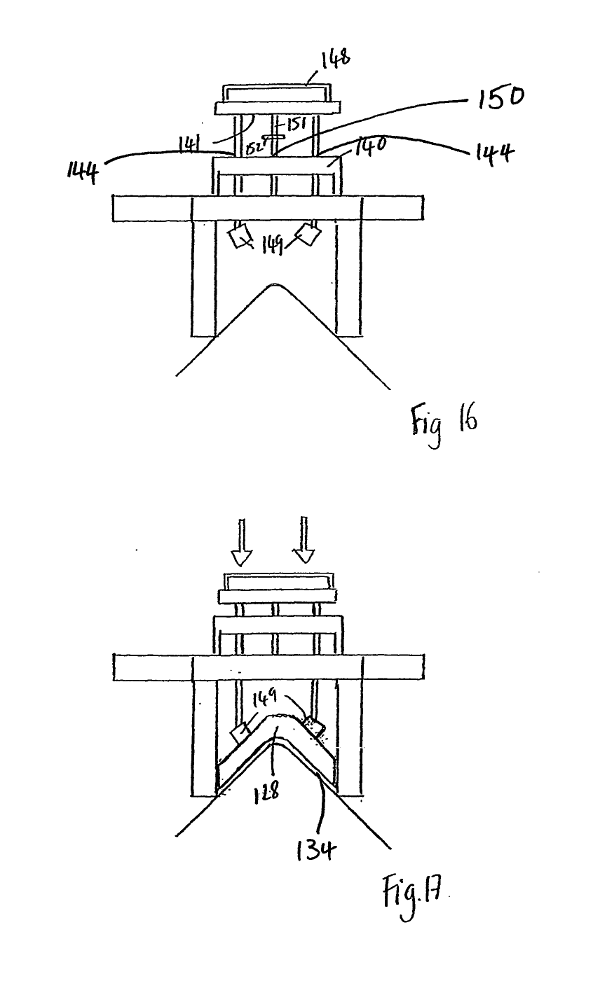

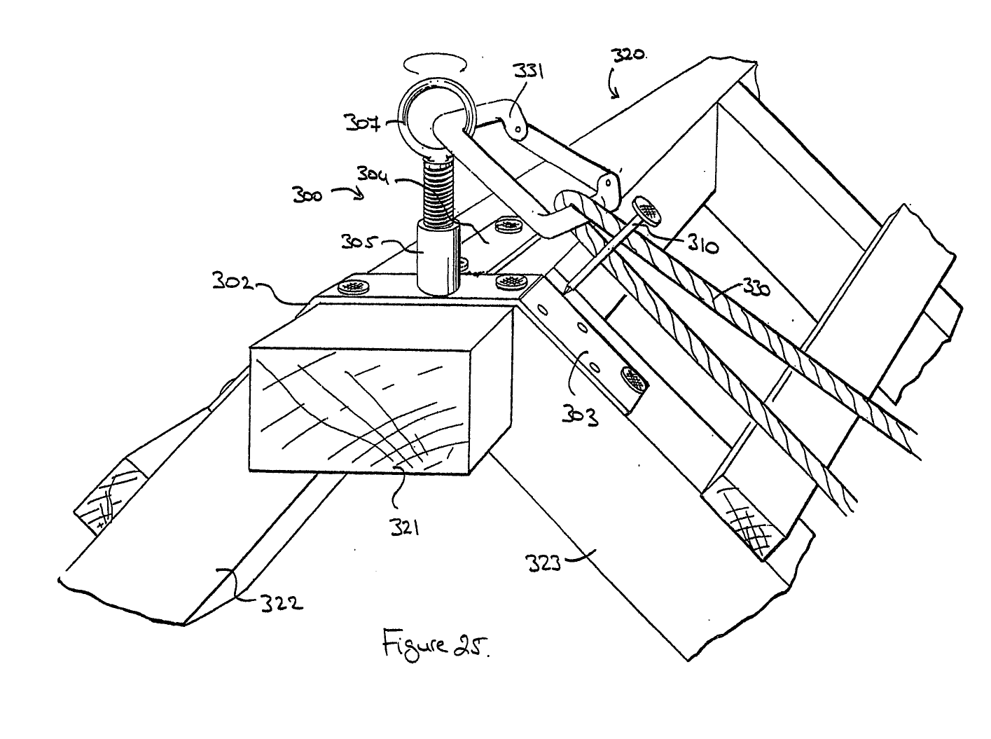

FIGS. 1 to 23 show various embodiments of a tile positioning device (and parts thereof) for height adjusting a tile located on a roof hip or ridge joint, in accordance with the present invention. FIGS. 23-24 show a securing element for use with the tile positioning device.

Each embodiment of the tile positioning device comprises two opposing spaced apart longitudinal side portions or members 2,102,202 arranged for straddling a roof hip or joint. The side members are maintained in a parallel configuration by at least one cross-connector 4, 104, 204 interposed between the longitudinal side members 2, 102, 202. At least one tile-pressing element or tile-levelling portion 6, 106, 206 is mountable between the side members 2, 102, 202.

In use, the tile-pressing element 6, 106, 206 is arranged to act upon the upper face of a tile positioned between the longitudinal side members 2, 102, 202 so as to height position the tile relative to the device.

FIGS. 1 to 8 show a device 1 according to a first embodiment of the invention.

As shown in FIGS. 1 to 5, the device 1 comprises a pair of opposing longitudinal side members 2 of L-shaped cross section. Each side member 2 comprises an upright or vertical portion 3 and a horizontal portion 5. The side members 2 are formed from metal, such as steel. The upright 3 and horizontal 5 portions of each L-shaped side member 2 may be formed by bending a flat elongate sheet of metal about its longitudinal central axis. Alternatively, two elongate flat sheets may be welded together along their longitudinal edge to form the L-shaped members 2.

Attached to the upper face of each horizontal portion 5 are three posts 7a, 7b, and 7c. The posts are positioned one 7a, 7c at either end of each side members 2, with a third post 7b at a point midway along each side members length. The posts 7a, 7b, 7c are used to support a guide rail 12 a short distance above the upper face of each horizontal portion of the side members. The guide rail 12 extends the length of each side member 2 linking the three posts 7a, 7b, and 7c.

The first 2a and second 2b side members are held parallel to one another by a pair of cross-connectors 4. Each cross connector 4 is a rod which links the end posts 7a, 7c of the first side member 2a to the end posts 7a, 7c of the second side member 2b. A first end 4a of each rod 4 is secured within the end posts 7a, 7c of the first side member 2a. The end posts 7a, 7c of the second side member 2b are provided with a central channel or bore 9 through which the far end 4b of each rod 4 passes. The rod 4 passes freely through the post 7a, 7c so that the spacing between the parallel side members 2 may be varied. A clamp 13 is provided on each end post 7a, 7c of the second side member 2b. The clamp 13 comprises a locking pin 15 that extends into the post 7 at right angles to the bore. The locking pin 15 acts upon the rod within the bore to restrict its movement through the bore. A lever 17 on the outside of the post 7 activates the advancement of the locking pin 15. By locking the post 7 at a desired position along the connector rod 4, the parallel side members 2 are held a desired distance apart.

It will be appreciated that in alternative embodiments of device, the distance between the parallel side members 2 may be fixed, for use with tiles of a set width.

As shown in FIGS. 1 to 5, two tile-pressing elements 6 are provided, one either side of the central posts 7b. Each tile-pressing element 6 is mounted on a rectangular carrier 18. Each carrier 18 is adapted to slide along the guide rails 12.

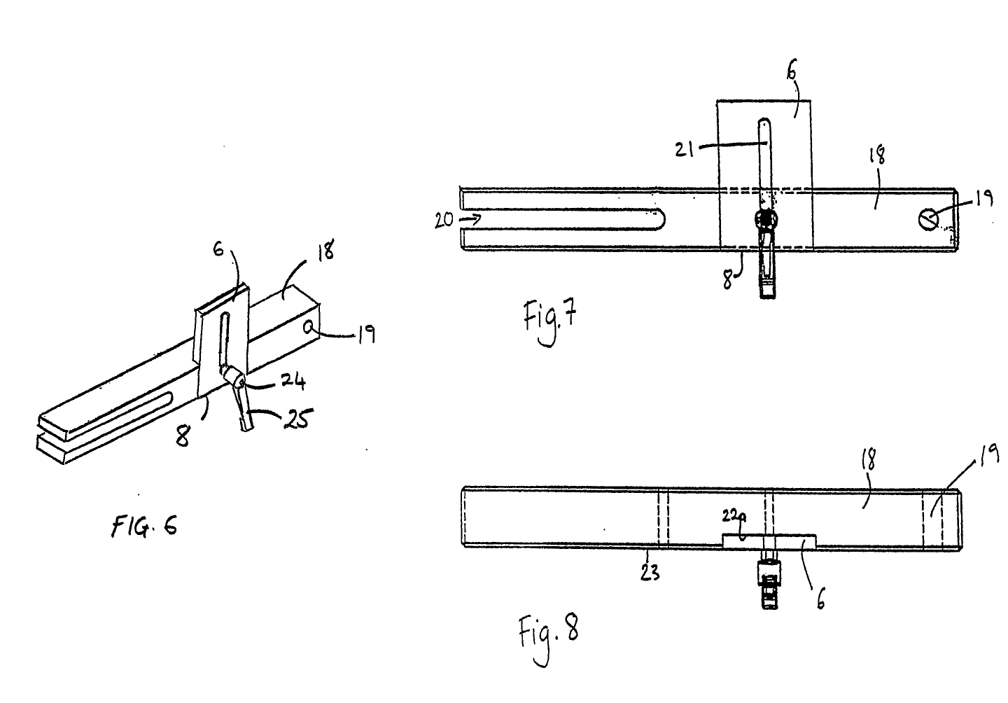

FIGS. 6 to 8 show one tile-pressing element 6 and carrier 18 of FIGS. 1-5, in greater detail. One end of the carrier 18 is provided with a cylindrical bore 19 through which the guide rail 12 of the second side member 2b freely passes. The other end of the carrier 18 is provided with a horizontal slit 20 which extends inside the carrier for about a third of its length, as shown in FIG. 7. The slit 20 is dimensioned to receive the guide rail 12 of the first side member 2a, as shown in FIG. 1. As the separation between the parallel side members 2a, 2b is increased, the guide rail 12 of the first side member 2a moves towards the opening of the slit 20, and vice-versa.

Each tile-pressing element 6 has an actuating portion and a tile-engaging portion, wherein the tile-engaging portion is height adjustable relative to the carrier 18. Each tile-pressing element 6 is a substantially rectangular plate.

The plate 6 has a central vertical slit 21. The plate 6 is received into a recess 22a formed within the side face 23 of the carrier 18, so that its outer face 6a is flush with the side face of the carrier 18. A pin or bolt 24 extends from the recess 22a within the carrier 18 and passes through the slit 21 in the plate 6. Locking means in the form of a levered nut 25 are attached to the end of the bolt 24. In an open (unlocked) position, the nut 25 is loose and the plate 6 is free to slide along its vertical axis relative to the carrier 18 within the recess 22. In a locked position, the nut 25 is tightened against the plate 6 and movement of the plate 6 relative to the carrier 18 is restricted.

The tile-engaging portion of the tile-pressing element is the base 8 of the plate 6. In use, the base 8 engages the upper surface of a tile positioned between the side members 2 of the device.

In use, the side members 2 of the device define an area between them into which a tile is to be laid. As seen best in FIGS. 1 and 2, the opposing faces 11 of the upright portions 3 of the side members comprise a tile protection member. In the present embodiment, the tile protection member is a wood laminate, however it will be appreciated that any material such as a plastics material may be used. The wood laminate assists in preventing damage to the tile by the metal side members 2. A wooden laminate has the added function of assisting in the drying or setting of a workable bonding material which may be used to affix the tiles to the roof.

In use, the device 1 straddles the hip or ridge of a roof. The lower edge 10 of each upright portion 3 of the side members 2 rests on the roof's surface on either side of the hip/ridge joint.

It will be appreciated that, in use, the guide rails 12 of the device may also be used as a temporary tile-rest onto which each tile may be rested prior to it being laid.

Before use on a roof, the width of the device may be adjusted in accordance with the size of tile to be laid. A sample tile is first laid on a horizontal surface (typically the ground). The device is then laid over the tile so that the underside 10 of the side portions 2 rests on the ground either side of the tile. The clamp 13 on the end posts 7a, 7c of the second side member 2b is unlocked so that the distance between the opposing side members 2a, 2b is adjustable. The device is adjusted until the opposing upright faces 11 of the side members 2a, 2b engage with the outer edges of the tile. The clamp is then activated to lock the device 1 at its set width. The device 1 may then be raised onto the roof ready for use.

The device 1 of the present invention acts primarily as a tile alignment and levelling, or positioning, device 1. However a number of safety features are incorporated into the device 1. It will be appreciated that the user of the device 1 needs to be able to safely work with the device 1 whilst maintaining a safe position on the roof. The device of FIGS. 1-5 is designed to act not only as a tile-positioning device but also as a roof ladder to support the user.

As shown in FIGS. 1-3, the device 1 is provided with support means (footholds/hand holds) in the form of outwardly extending brackets 22, which extend from each longitudinal side member 2. The brackets 22 are bolted to the underside of the horizontal portion 5 of each side member 2. It will be appreciated that in alternative embodiments, the brackets 22 may be welded to the side members, or alternative connection means may be provided. The brackets 22 act as footholds for the user in a manner similar to the rungs of a ladder. By positioning his feet on these brackets 22, the user may straddle the device 1. Alternatively a user may work from one side of the device with his/her weight supported by the brackets 22. In the device 1 of FIGS. 1 to 6, four sets of brackets 22 are provided although it will be appreciated that any number of brackets or alternate support means may be provided in accordance with the present invention.

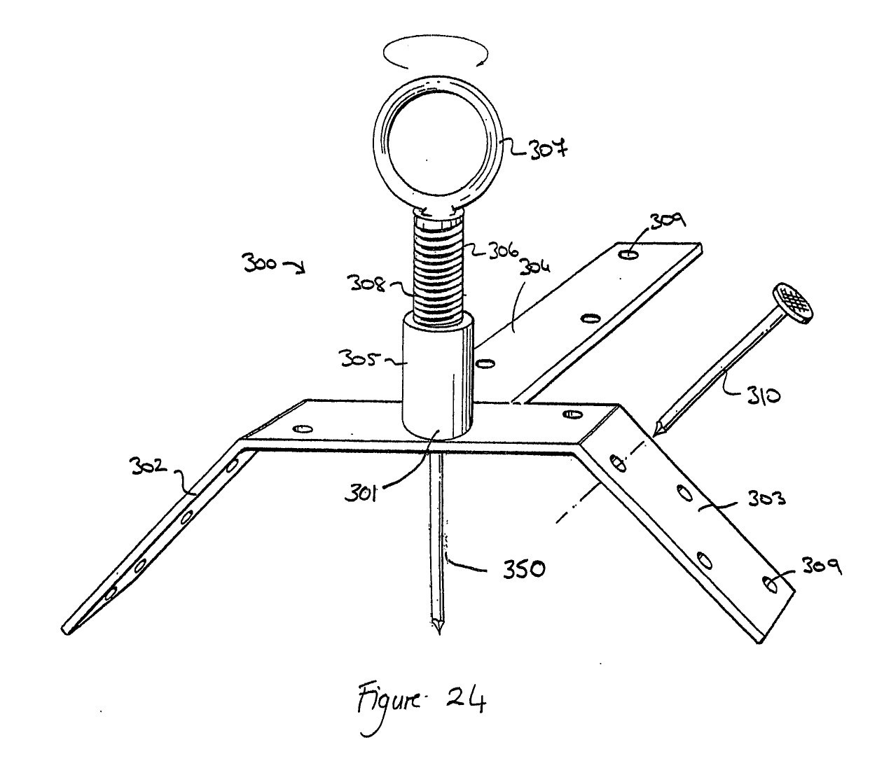

In alternative embodiments of the device (see in particular FIG. 22 below), the brackets or rungs may be spring-loaded, wherein the user's foot is used to displace the rungs from an upright stowed position to a horizontal in-use position. When the foot is removed from the rung, the rung returns under the spring to its upright rest position. The rungs only extend outwardly from the device during use and therefore make the device more streamlined when not in use.

If the device 1 is to support not just its own weight but also the additional weight of the user, means must be provided to secure safely the device 1 to the roof. Such means are described below with reference to FIGS. 22-23.

At least one end of the device 1 is provided with two rope connection points 24 in the form of hoops or eyes, which have been screwed into the end posts 7a, 7c. A rope or safety line may be secured to the hoops.

FIG. 9 shows the device 1 in position on a hip 30 of a roof ready for use. A rope 31 connects the rope connection points 24 on the device 1 with an anchor point 26 located at the ridge of the roof. The same anchor point 26 may further to used to secure the user directly to the roof via a harness arrangement (not shown). Ideally, the anchoring arrangement further enables the user to “abseil” up or down the hip 30 of the roof when using the device 1 to lay hip tiles.

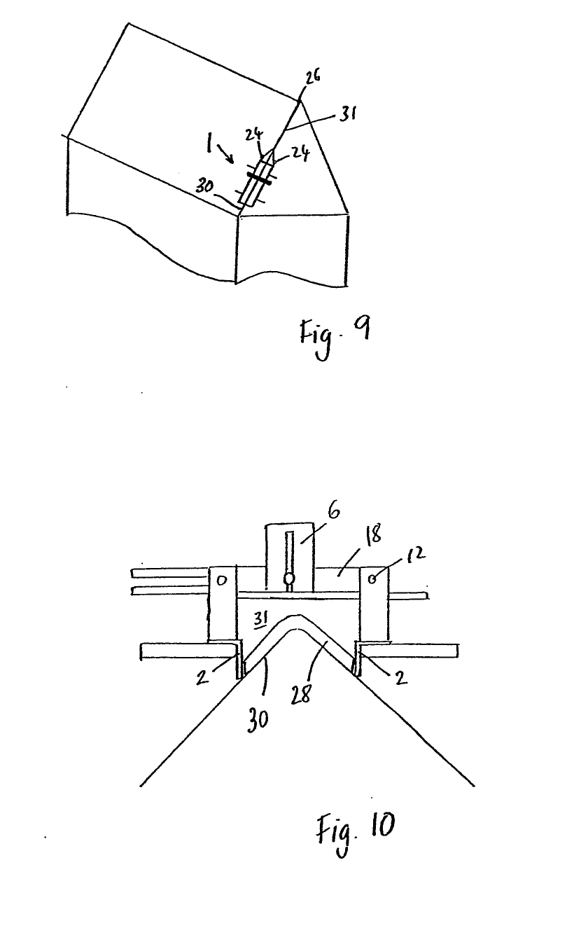

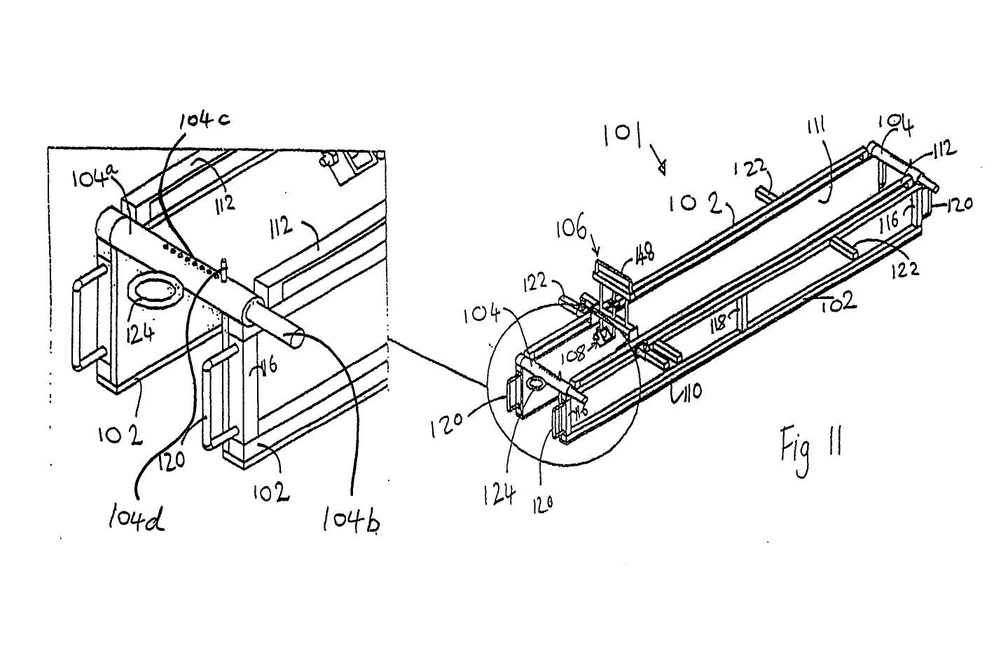

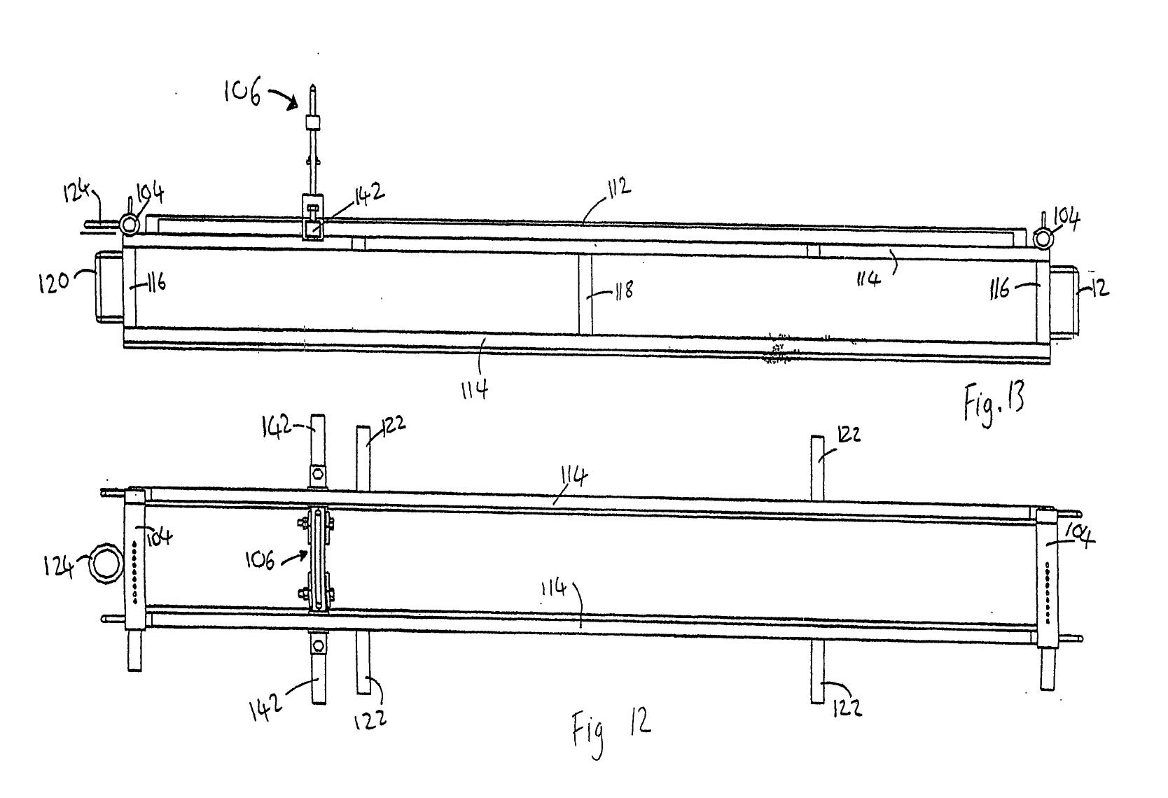

FIG. 10 is a cross-sectional view of the arrangement of FIG. 9. The device 1 straddles a hip 30 on to which a row of hip tiles is to be laid. A method of use of the device of FIGS. 1 to 8 will now be described, with reference to FIG. 10 and FIG. 3.

A layer of workable bonding material, typically mortar, is first applied to the hip 30 within the tile-receiving region 31 defined between the side members 2 of the device.

A first tile 28 is laid on the mortar (not shown) between the parallel side members 2 of the device. With the plate 6 of the tile-pressing element locked in its upmost position (as shown in FIG. 10), the carrier 18 is slid along the guide rails 12 until positioned over the tile. The plate 6 is then unlocked and lowered a predefined amount. The lowering of the plate 6 beds the tile a predetermined depth into the underlying mortar. The depth is maintained for each tile to ensure a resultant level line of tiles. When the first tile had been laid and bedded into the mortar, the device 1 is ready to receive a second tile. If required, additional mortar may be applied to the hip at this stage. The second tile is placed between the parallel side portions 2 of the device 1, with one edge of the tile in abutment with one edge of the previously laid tile. The carrier 18 is then slid along the guide rail until repositioned over the second tile. The plate 18 is used in the matter described previously to bed the tile into the mortar. The setting of the arrangement ensures that the second tile is laid at the same level as the first tile.

The above steps are repeated until the entire line of tiles has been laid.

In an alternative method, the plate may be locked at a desired height prior to the laying of a tile. For example, this may be carried out on the ground at the same time as the device width adjustments are carried out. If the pre-locking has been carried out and the mortar laid as above, a line of two or more tiles may be laid on the mortar between the parallel side members 2 of the device. With the plate 6 of the tile-pressing element locked in pre-set position, the carrier 18 is slid along the guide rails 12 above the line of tiles. As the carrier slides, the lower edge of the plate engages with the upper surfaces of the tiles to bed each tile a predetermined depth into the underlying mortar. As the height of the plate relative to the device is fixed, the bedding depth is maintained for each tile to ensure a resultant level line of tiles.

It will be appreciated when using either method that when the laid tiles reach the midpoint of the device, the first tile-pressing element 6a becomes redundant and the second tile pressing element 6b is used on the remaining tiles to be laid between the middle post 7b and the far end post 7c. When a line of tiles the length of the device has been laid, the device may be moved up or down the hip of the roof ready to be used to lay the next line of tiles.

Typically however, hip files are laid from the bottom of the roof to the top along each hip. It will be appreciated that the above method is not exclusive to the positioning of hip tiles and may be used also to position ridge tiles along the ridge of a roof.

After a line of tiles has been laid it may be necessary for the roofer to return to the tiles to tidy up and to remove any excess mortar from the area. This is easiest when the mortar has dried. The wooden laminate on the opposing faces of the side members 2 has a drying effect on the mortar as the wood absorbs moisture from the mortar. The wooden laminate therefore speeds up the drying time of the mortar, thereby speeding up the overall tile laying process.

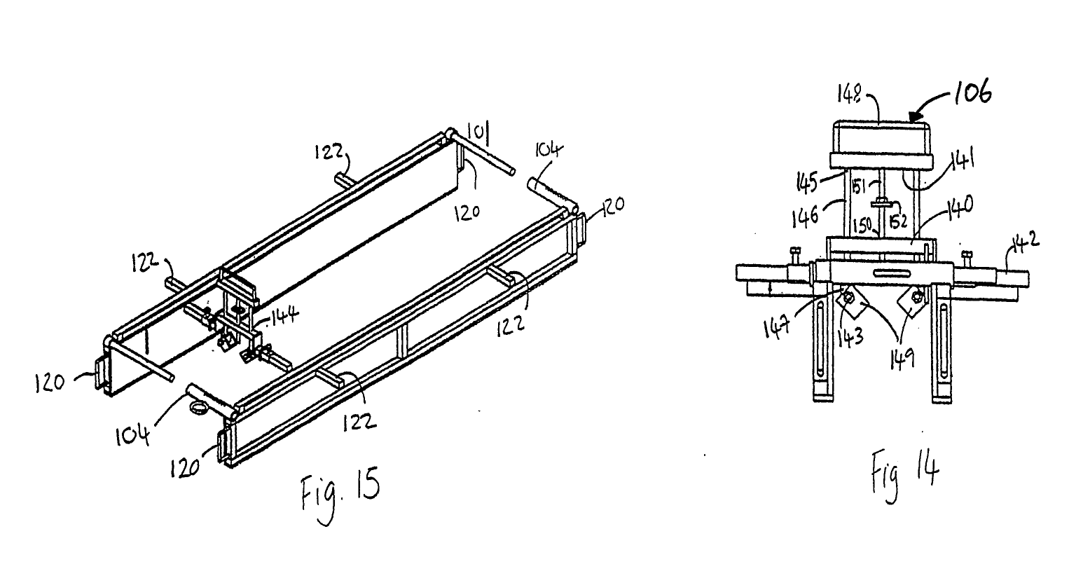

FIGS. 11 to 17 show a device 101 according to a second embodiment of the invention. This embodiment differs from the first in that the side portions 102 are formed from lengths of metal box-section welded together into a rectangular frame having two parallel elongate members 114 connected by two end members 116 and one central support member 118. The central support member 118 imparts strength and rigidity to the frame. The frame is preferably steel, although it will be appreciated that alternative materials such as wood or plastic may be employed in the construction of the frame.

The tile-pressing element 106 is slidable longitudinally along the length of the device 101 within guide rails 112 provided on the upper surface of each side portion 102.

The connectors 104 are variable in length, thereby enabling the spacing between the parallel side portions 102 to be varied.

Handles 120 are provided on each end cross member 116 of the frame to improve the portability of the device 101.

As best seen in FIG. 14, the longitudinally moveable tile-pressing element 106 comprises a bridge portion 140 having outwardly extending arms 142. The arms 142 are dimensioned to slide within the guide rails 112. The bridge portion 140 is provided with a pair of vertical bores or passages or guide holes 144 through which pass a pair of vertically aligned rods 146. The rods 146 are linked at their upper ends 45 by a handle portion 148. The handle portion 148 is moveable vertically relative to the bridge portion 140 as the rods 146 are free to pass through the guide holes 144 in the bridge portion 140. The free ends 147 of the rods 146 distal to the handle 148 are provided with tile engaging pads 149. The pads 149 are pivotally mounted at the free ends 147 of the rods 146 and secured by means of pins 143 or similar fastening means.

As shown in FIGS. 16 and 17, the pivotable nature of the pads 149 ensures a coupling of at least one surface of the each pad 149 against the inclined upper surface of a tile 28 positioned below it.

A movement of the handle 148 towards the bridge 140 effects a movement of the pads 149 away from the bridge 140, thereby allowing the user to apply pressure through the pads 149 to the tile 128, effectively bedding the tile 128 into the mortar 134 laid beneath it.

As shown in FIG. 16, the bridge 140 is further provided with a third hole 150 or bore located equidistant between the two guide holes 144, through which a control pin 151 is free to pass. The upper end of the control pin 151 is secured to the underside 141 of the handle portion 148. The control pin 151 is provided with a moveable nut 152. By positioning the nut along the length of the pin 151 between the handle 148 and the bridge 140 it is possible to limit the displacement of the tile 128 by the tile-pressing element 106.

It will be appreciated that in alternative embodiments the handle may be spring-loaded.

FIGS. 11 and 15 show the cross-connectors 104 in greatest detail. Each connecting member comprises a first portion 104a and a second portion 104b. Each portion 104a, 104b is provided with a series of vertically aligned holes 104c. The second portion 104b is dimensioned to telescope into the first portion 104a. A securing pin 104d is provided which is dimensioned to pass through the holes 104c in the respective portions 104a, 104b thereby fixing the total length of the connecting member in accordance with the width of tile to be laid.

Outwardly extending brackets or footholds extend from each longitudinal side member 102.

A hoop 124 is provided for attachment of the device to a roofline. The hoop is positioned on a cross connector at one end of the device.

It will further be appreciated that the side portions of the device 101 may take other forms. A limitation of the structure of the device 101 is that the connecting members 116, 118 must be sufficiently raised above the underside of the side portion 102 resting on the roof, so as to provide sufficient clearance for the hip. It is therefore preferred that the device 101 maintains a substantially U-shaped cross-section.

The length of the device may be variable, for example the device may be telescopic. The device may be used as a singular device or a series of devices may be interconnectable to increase the resultant length of the device.

FIGS. 18-21 show a tile positioning device 202 according to the present invention which is very similar in construction to that shown in previous Figures—particularly FIGS. 1 to—10.

The device 201 has opposing side members 202 which are of L-shaped cross section similar in construction to those in the earlier Figures. The device has three pairs of opposing posts 207a; 207 b and 207c. One form each pair of posts support the respective guide rails 212.

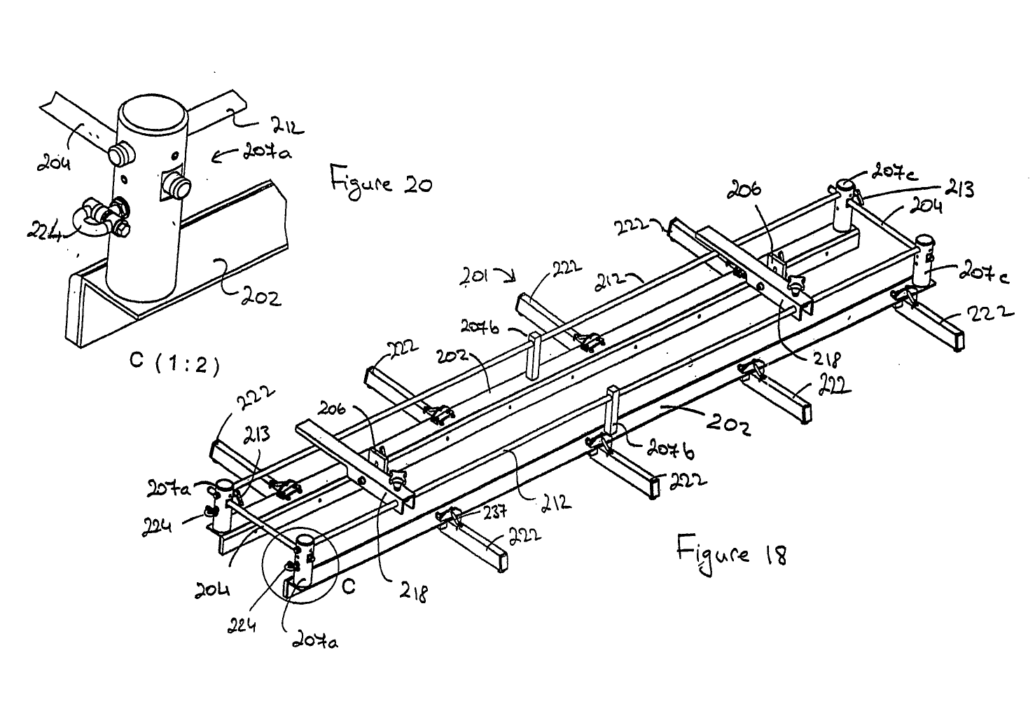

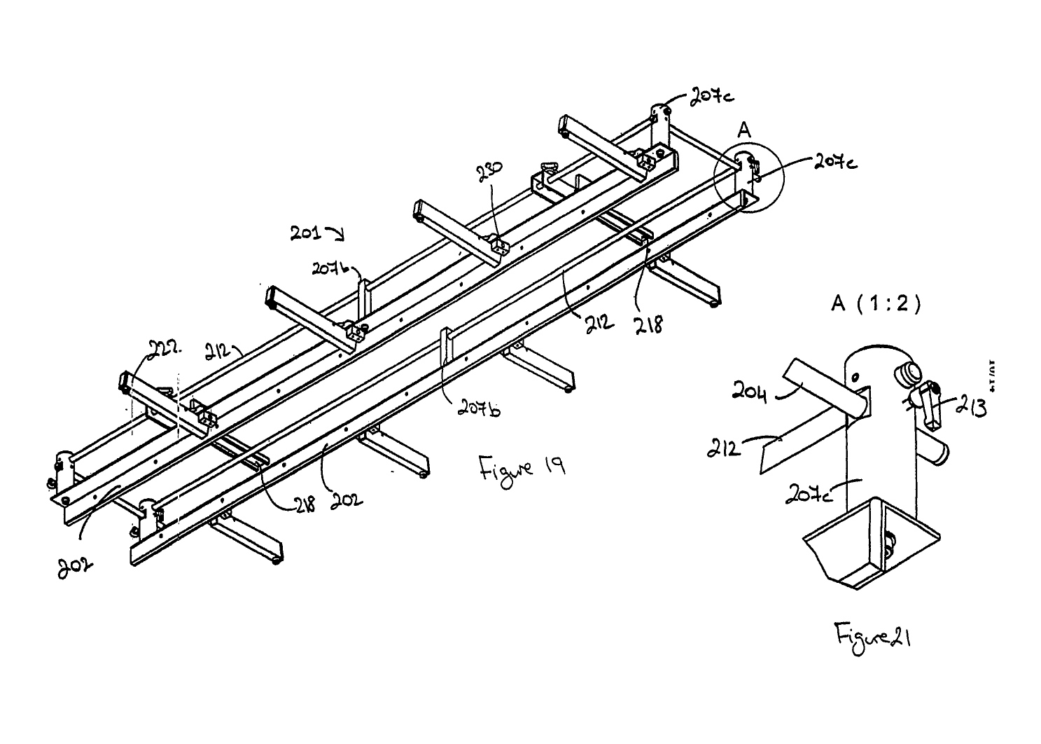

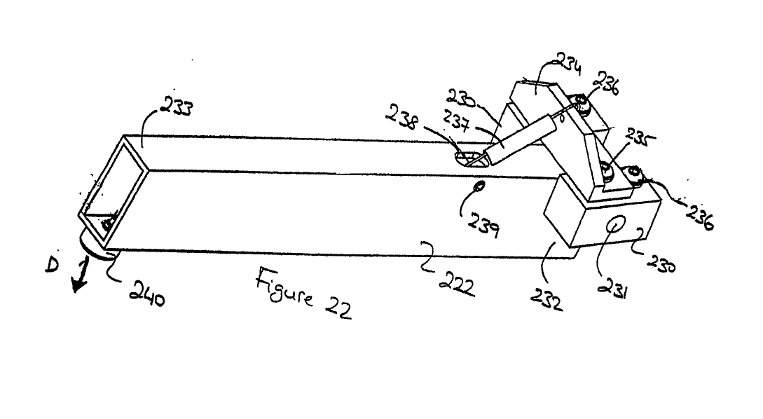

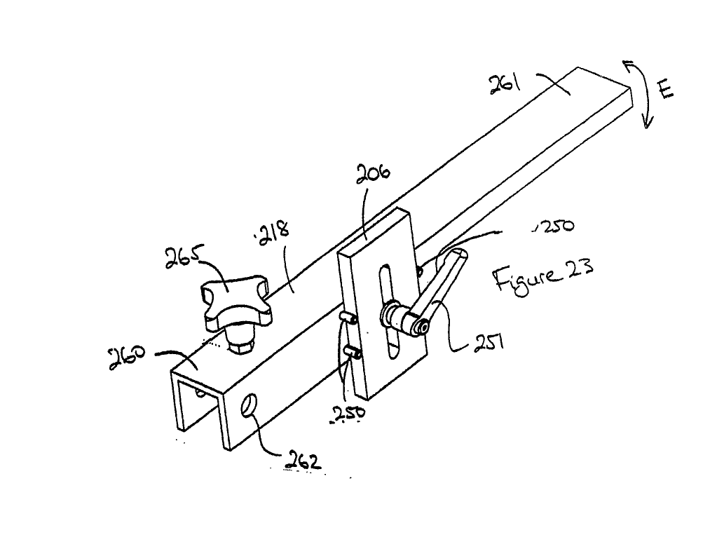

Apart from the generally cylindrical shape of the posts there some additional distinctions from earlier embodiments which are best seen from FIGS. 20 and 21. FIG. 20 shows an enlarged view of the post 207a of the device 201 which is encircled by circle “C” in FIG. 18. As can be seen the post 207a has fitted thereto an eye 224 to which a securing line may be attached. An eye 224 is provided on each post 207a so that each side of the device 201 can be secured easily to a securing line.

FIG. 21 shows the an enlarged view of post 207c. It can be seen that (in common with earlier embodiments) one post 207a and one post 207c (on the same side of the device) are each fitted with a clamp 213 (which operate in same manner as clamps 13) to allow adjustment of the space between the side members 202.

A further aspect of the device shown in FIGS. 18-20 that differs from earlier embodiments is that the rungs/brackets/footholds 222 are biased away from a roof engaging position to a non-roof engaging position. In particular as best seen from FIG. 22 each rung 222 is attached to the device by opposing mounting members 230 which each house an aperture for mounting a pivot pin 231, which runs through a first end 232 of the rung 222. The first end 232 is proximate the side rails 212 in the embodiment shown. The rung 222 has a second free (non-attached) end 233. A mounting bracket 234 is mounted to the mounting members 230 by fasteners 234, while fasteners 236 can be used to mount the entire assembly to the device. The bracket 234 forms a retainer for one end of a tension spring 237, while an aperture 238 in a top wall of the rung 222 allows the other end of the spring 237 to be fixed to a pin 239 mounted transversely between the side walls of the rung 222. A contact pad 240 is mounted on the free end of the rung 222 on the phase thereof and acts to protect a roof from direct contact with the (free end of the) rung 222.

The assembly is adapted so that the rung 222 is biased away from a normal roof-contacting position. As shown in FIGS. 18 and 19 in particular the rest position for each rung 222 is a raised position away from the roof contacting position. An advantage of providing this rest position is that when the device is being moved (for example by sliding) along the roof the rungs 222 (and in particular the contact pad 240) do not catch on any exposed outer lips of any of the roofing elements such as roof tiles or indeed and other raised surface thereon. The skilled person will appreciate that overlaid roofing elements can catch on an article which is slid into place up along the roof.

When weight of a user (such as a foot or hand) is placed on the rung 22 it moves (against the bias of the spring 237) in the direction of arrow D in FIG. 22 (and in use downwardly) until the contact pad 240 rests on the roof. The weight of the user is thus transmitted by one or more rungs to the roof and/or the remainder of the device. When the weight is removed the rung 222 moves upwardly again under the bias from the spring 237. In this non-operative position it is easier to move the device upon the roof. Generally the rung will move through an angle of about 45 degrees or less between the operative and inoperative positions.

If desired (and as described above) the rungs 222 could be arranged to move to a stowed position where the free ends are moved into a position closer (in a transverse direction of the device) to the side members. Such position may be suitable for stowing the rungs 222.

FIG. 23 shows the tile-pressing element in the form of an adjustable plate 206 of the device of FIGS. 18 and 19 which is similar to the arrangement shown in FIG. 6. The tile engaging element 206 and a carrier in the form of a handle 218 form a tile-engaging assembly. The plate 206 is mounted between guides in the form of pins 250. A clamp arrangement 251 allows for height adjustment of the element 206 relative to the handle 218. The handle 218 has a first (free) gripping end 261 and a second (pivoting) end 260. The pivoting end 260 is free to pivot about a rail 212 (see FIG. 8 or 19) which is received within apertures 262 in the handle. In this way the handle is free to pivot about one rail 212 as indicated by arrow E. The handle is arranged to abut the other side rail 212. In this way the handle 218 can be pivoted about rail 212 so that it no longer obstructs in any substantial fashion a tile or bonding material such as mortar being placed between the side rails 202. Once a tile is in place the handle can be moved to the position shown in FIG. 18 so as to cause the tile pressing element 206 to act on the tile in a pre-selected manner. A knob 265 on the handle 218 provides a gripping means for sliding of the handle 219 along the side rail 212.

FIG. 24 shows a securing element 300 having a base 301 three fixing members in the form of metal straps 302-304 extending therefrom. The straps are for affixing the element 300 to a roof member. A retaining member in the form of an upstanding member 305 which forms a receiver for an anchor bolt 306 is provided. The retaining member and in particular a retaining eye or hoop 307 form an anchor point to which a securing line can be attached. Reciprocal screwthreads on the upstanding member 305 and the bolt 306 allow for interconnection of the two parts of the securing member.

The securing member is provided with apertures 309 which allow the securing element to be fastened to a roof such as with a nail 310. A securing element 350 may be integrally formed with the securing member so as to protrude from the base 301 to allow the base 301 to be secured to the roof, 320. The securing element 350 may be a spike. In an alternative embodiment the base 301, and metal straps 302-304 may house preformed securing elements such as spikes which may be located on the base 301 and metal straps 302-304 instead of the aperture 309.

As can be seen from FIG. 25 the securing element can be secured to a roof 320 such as the timbers of the roof. In particular as illustrated the device is fixed to a main roof beam 321, and inclined beams 322 and 333 by being nailed in position using the fixing straps 302-304.

A securing line 330 is used to secure a tile positioning device of the invention to the securing element 300. A catch or hitch 331 is employed to fasten the line to the eye 307. The base 301 may be left in its secured position after it has been used and the bolt 306 removed for re-use. It is thus possible to tile over the base 301. In use the upstanding member 305 is adapted to project above the roof, when in use and it and the bolt 306 together project above the level of any tiles to be laid by the device. The tie line 330 can be attached to any of the embodiments of positioning device by the various attachment points described above. In this way the securing device can be used to secure the device of the invention when in use to lay tiles along the ridge, or along either of the hips of the roof. The fixing members may be adjustable relative to each other so as to be securable to roof members at different relative orientations to each other. The fixing members are desirably sufficiently flexible to allow them to adjust to the profile of the roof members to which they are to be affixed. For example they may be in the form of metal straps which can be bent into a desired shape.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A tile positioning device for height adjusting a tile located on a roof hip or ridge joint, each tile having upper and lower faces, the device comprising:
two opposing longitudinal spaced apart side members arranged for straddling a roof hip or ridge joint,
means for maintaining the longitudinal side members in a substantially parallel configuration, and
at least one tile-pressing element mounted between the longitudinal side members, the or each tile-pressing element being arranged to act upon the upper face of a tile located between the longitudinal side members, so as to height position the tile relative to the device.

2. The device of claim 1, wherein the at least one tile-pressing element has a degree of freedom along an axis perpendicular to the longitudinal axis of the longitudinal side members.

3. The device of claim 1, wherein the at least one tile-pressing element has a degree of freedom along the longitudinal axis of the side members.

4. The device of claim 1 wherein the at least one tile-pressing element is mounted to a carrier which has a first end which is pivotably mounted on the device, and a second free end, so as to allow the tile-pressing element to be moved from an operative position to an inoperative position where the free end of the carrier is pivoted away from the device.

5. The device of claim 4 wherein the tile pressing element is adjustable relative to the carrier.

6. (canceled)

7. The device of claim 1, wherein the at least one tile-pressing element comprises an actuating portion and a tile engaging portion.

8. The device of claim 1, wherein the tile engaging portion comprises a pair of pads, for engagement with the upper face of a tile, the tile having an apex, wherein each pad is positioned to engage the upper face of the tile at either side of the apex.

9. (canceled)

10. (canceled)

11. (canceled)

12. The device of claim 1, wherein the means for maintaining the longitudinal side members in a substantially parallel configuration is adjustable so as to allow the spacing between the longitudinal side members to be varied.

13. The device of claim 1 further comprising securing means for securing the position of the device relative to a tile.

14. The device of claim 13, wherein the securing means comprises a safety line attachable to a roof ridge.

15. The device of claim 1 further comprising support means for supporting a user of the device.

16. The device of claim 15, wherein the support means are hand and/or foot holds.

17. The device of claim 16, wherein the hand and/or foot holds are displaceable between an in use position and a stored position.

18. The device of claim 17 wherein the hand and/or foot holds are biased away from an operative roof-engaging position toward an inoperative non-roof-engaging position.

19. The device of claim 18 wherein the hand and/or footholds have a first end attached to the device and a second free end and further comprising a contact pad mounted on the free end of the or each hand and/or foothold and arranged to abut the roof in the roof engaging position.

20. The device of claim 16 wherein the hand and/or footholds move from an inoperative position to the operative position when user weight is placed thereon.

21. (canceled)

22. (canceled)

23. (canceled)

24. A method of height adjusting a tile located on a roof hip or ridge joint, each tile having upper and lower faces, comprising the steps of:
(i) applying an amount of workable bonding material to the hip or ridge joint;
(ii) straddling the roof or hip or ridge joint with a tile positioning device having two opposing spaced apart side members;
(iii) maintaining said side members in a substantially parallel configuration by at least one cross connecting member; and
(iv) providing a tile-pressing element arranged to act upon the upper face of a tile located between the side members, so as to height position the tile relative to the device.

25. (canceled)

26. A tile positioning device for positioning a tile on a roof hip or ridge joint, the device comprising:
two opposing longitudinal spaced apart side members arranged for straddling a roof hip or ridge joint,
means for maintaining the longitudinal side members in a substantially parallel configuration, and
at least two foot and/or hand holds extending outwardly from the device.

27. The device of claim 26, wherein the foot and/or hand holds are displaceable between an in-use position and a stowed position.

28. A tile-positioning device according to claim 1 further comprising a securing element having a base with at least one fixing member extending therefrom for affixing to a roof member; a retaining member on the base, the retaining member forming an anchor point to which a securing line can be attached.

29. The tile-positioning device of claim 28 further comprising a securing line for securing the tile positioning device to the securing element.

30. The tile-positioning device of claim 28 wherein the securing element is constructed of interconnecting components and comprises: a first component which is a securing element having a base with at least one fixing member extending therefrom for affixing to a roof member a second component which is connectable to the first component to form the retaining member.

31. (canceled)

32. (canceled)
